(19) United States
(12) Patent Application Publication
(10) Pub. No.: US 2019/0225032 A1
(43) Pub. Date: Jul. 25, 2019

(54) RUN-FLAT DEVICE

(71) Applicant: HUTCHINSON, PARIS (FR)

(72) Inventors: Manuel LINCK, ERMONT (FR); Maxime HAYOT, FRANCONVILLE (FR)

(73) Assignee: HUTCHINSON, PARIS (FR)

(21) Appl. No.: 16/313,520

(22) PCT Filed: Jun. 30, 2017
(86) PCT No.: PCT/EP2017/066367

§ 371 Date: Dec. 27, 2018

(30) Foreign Application Priority Data
Jun. 30, 2016 (FR) 1656148

(51) Int. Cl. B60C 17/04; B60C 17/06

(52) U.S. Cl. CPC B60C 17/042; B60C 17/061

(57) ABSTRACT

The invention relates to a run-flat device for a mounted assembly of a motor vehicle and such a mounted assembly incorporating it.

This device comprises a wheel rim having a rim base of diameter D and a tire mounted on the rim, the device being suitable for supporting the tire in a run-flat situation and comprising:
a ring comprising a multitude of axial portions juxtaposed over a circumference of the ring and defining an inner mounting face on the rim base and an outer support face of the tire in a run-flat situation, each portion having at least one support situated radially between the mounting and support faces, and
at least one belt which surrounds the ring over the circumference thereof so as to support it substantially in contact with the rim base and which passes through the portions by being applied on the supports thereof.

According to the invention, the portions are not hinged to one another and are tight or spaced apart from one another over the circumference by a total sum of consecutive spaces, measured between the portions at the mounting face thereof, which is less than π·D/2.

The present invention relates to a run-flat device intended to equip a mounted assembly for motor vehicles and such a mounted assembly incorporating this device, making it possible to travel a significant distance at a relatively high speed when the mounted assembly is partially or totally flat.

For a one-piece rim, the known run-flat devices are generally constituted by a rigid support ring which is mounted clamped around a wheel rim inside a tyre. This ring is, for example, formed either of one single part at the relatively flexible flanks which could be continuous or one flexible open part (i.e. split), or of at least two rigid parts in a circular arc or sectors.

Document WO-A1-2008/132348, in the name of the Applicant, has a run-flat device in particular for a one-piece rim with a rim nave, provided to optimise the radial wedging in the inflated state of the ring on the rim (by limiting the “centrifugation” thereof). This device comprises a ring having an outer support face of the tyre in a run-flat situation and, on the mounting face thereof on the rim, means such as a lip or axial tab to wedge the ring in this nave by moulding the profile thereof, and a belt which surrounds the ring by being applied on a reinforcement of the support face thereof. This belt can be provided with reversible connection and locking means with an adjustable clamping from the two adjacent ends thereof, as detailed in document EP-A1-2 233 752, also in the name of the Applicant.

Document CN-B-101362421 presents a run-flat inflatable device for a one-piece rim, provided with rubber support elements, circumferentially spaced apart, each comprising two radially inner and outer soles, such that the circumference of the device is covered very slightly by these elements and mainly by a clamping belt passing through them.

A major disadvantage of the devices known for a one-piece rim in particular resides in the increased production cost thereof, because of the geometry thereof specific to each rim and the tooling required for the assembly thereof. In particular, the complexity of the device according to CN-B-101362421 generates an increased production and assembly cost.

For a multi-block rim, the known devices are generally constituted by a support ring split into sectors connected to one another by a rigid assembly and clamping connector around the rim, and by means for blocking the tyre beads against the rim edges intended to connect these sectors to the beads to ensure the driveability of the assembly mounted in case of reduced pressure in the latter.

Document EP-B1-1 550 566 discloses a run-flat device for a multi-block rim comprising a ring which is constituted of a circumferential juxtaposition of a large number of hollow and compartmentalised sectors and on a radial reinforcement from which is applied a lockable clamping belt. These sectors are connected two-by-two to one another, closely by hinges. It must be reminded that, by definition, a “hinge” is an assembly of which the connecting element is formed by an axis or by a ball making it possible for an angular movement relating to assembled parts (Larousse). In the case of document EP-B1-550 566, the assembled parts correspond to the sectors which are connected by an axle-type connecting element (axle 16 in FIG. 7 of this document). Moreover, in this document, the sectors each have a radially inner mounting face which is open on the rim.

A major disadvantage of known devices for a multi-block rim resides, in particular in the need to use a specific tool to insert them and lock them inside the tyres. In addition and relating to the device according to EP-B1-1 550 566, the complex structure of the hinged sectors also makes it difficult for the assembly of the device inside the tyre by penalising the production and assembly cost thereof.

An aim of the present invention is to propose a run-flat device for a motor vehicle-mounted assembly comprising a wheel rim having a rim base of diameter D and a tyre mounted on the rim, the device being suitable for supporting the tyre in a run-flat situation by overcoming, in particular, the abovementioned disadvantages and comprising:

a support ring comprising a multitude of n axial portions (n could be advantageously equal to or greater than 12, even 25, and even more advantageously, 50) which are juxtaposed over a circumference of the ring and which define a radially inner mounting face, suitable for being mounted on said rim base and a radially outer support face, suitable for supporting the run-flat tyre, in a run-flat situation each of said portions having at least one support situated radially between said mounting face and said support face, and

at least one support belt which clamps the ring on said circumference so as to support it substantially in contact with said rim base and which passes through said portions by being applied on said at least one support of each of them.

To this end, a run-flat device according to the invention is such that said portions are not hinged to one another and are tight or spaced apart between one another over said circumference by a total sum of consecutive spaces, measured between said portions at said mounting face, which is less than π·D/2.

According to another characteristic of the invention, said at least one support belt can have two belt ends spaced apart and connected to one another by connecting and locking means capable of locking said at least one belt, which could moreover ensure a clamping, advantageously adjustable of the portions. Advantageously, these means forming a lockable connector can be such as disclosed in EP-A1-2 233 752, although other connectors can be used in the present invention.

By “axial portions”, this means, in the present description, three-dimensional portions of which the portion thickness in the circumferential direction of the ring, measured in the inner mounting face thereof, is less than the width thereof and the height thereof, respectively in the axial and radial directions of the ring. Thus, these axial portions mainly define, in the front faces thereof of the severed portions along axial meridian or non-meridian planes (i.e. which pass or do not pass through the axis of revolution of the ring by being mainly perpendicular to the median circumferential plane thereof). In other words, these front faces of axial portions can be contained in or slightly tilted with respect to these meridian planes.

By “tight portions”, this means, in the present description, such axial portions which are two-by-two substantially in contact at axial edges facing the respective mounting faces thereof, via:

a small or zero axial clearance in the circumferential direction (this clearance can vary over the circumference of the ring and is, for example, between 0 mm and 10 mm, advantageously between 0.5 mm and 5 mm) over all or part of the circumference of the ring, and/or

shims of radial height less than that of the portions and inserted between two consecutive portions over all or part of the circumference of the ring (these shims will be described following the present description), also with such a small or zero axial clearance which could be variable over this circumference (for example, between 0 mm and 10 mm, advantageously between 0.5 mm and 5 mm) arranged between each chock and the two consecutive portions which are adjacent to it.

It will be noted however, that the connection interval separating, in the circumferential direction, the two ends facing said at least one support belt and integrating said connecting and locking means, has no portion at all and must extend over a distance greater than this axial, circumferential clearance to be able to access, under good conditions, these means. This interval can, for example, extend over a distance of between 30 mm and 70 mm, advantageously between 40 mm and 60 mm.

By “portions spaced apart from one another”, this means, in the present description, such axial portions which do not meet this definition of tight portions over all or part of the circumference of the ring, and which are, for example, separated two-by-two from one another in the circumferential direction by a distance greater than 10 mm, even 20 mm. Indeed, it is not essential for the present invention to have such tight portions over all or part of the circumference of the ring.

By “total sum of consecutive spaces” less than π·D/2 according to the present invention, here this means that the inner circumference π·Di of the discontinuous annular structure formed by the ring (of inner diameter Di in the mounting face thereof, with Di substantially equal to the diameter D of the rim base) is mainly occupied by the juxtaposed axial portions, which is conveyed by the fact that (with D˜Di):

the sum of all the consecutive circumferential spaces between the portions is less than π·Di/2 (i.e. less than half of the inner circumference of the ring), and consequently that

the sum of the circumferential thicknesses of all the portions is greater than π·Di/2 (i.e. greater than half of the inner circumference of the ring).

Advantageously, these portions can be spaced apart from one another by a total sum of consecutive spaces, measured at said mounting face, which is less than π·D/4 and even more advantageously less than π·D/8 (which means that the inner circumference π·Di of the ring is occupied at least by three-quarters or at least seven-eighths, respectively, by the juxtaposed portions).

Also advantageously, the portions can each have, over all or part of said circumference of the ring, a circumferential portion thickness measured in the mounting face thereof less than or equal to π·D/25 that is around D/8, and even more advantageously, less than or equal to π·D/50 that is around D/16 (still with D˜Di).

It will be noted, that these axial portions according to the invention which are connected, without hinges between them (i.e. without any connecting element, of axle or ball type, in particular akin to a fixing, between consecutive portions) have the advantage of being able to be achieved easily and according to a reduced production, assembly and mounting cost inside the mounted assembly. Indeed, a device according to the invention is presented advantageously, before the mounting thereof inside the tyre, in the form of a flat, linear strip which is easy to package and to handle. It can also be devised, that the device is delivered unassembled, namely in kit form.

With respect to the mounting of a device according to the invention on a one-piece rim, it will be noted that some of the portions cannot have any lip or radially inner shim tab in the rim nave, contrary to the device according to WO-A1-2008/132348, for example.

Generally for portions according to the invention:

they can each independently be produced from:
one or more materials such as elastomers (rubbers or thermoplastic elastomers) and/or plastic materials (of thermoplastic and/or thermosetting polymer type), in a non-limiting manner, for example, by using a more damping material at the support face of the ring, and possibly according to different production methods, possibly combined, to obtain all the portions; and/or
one single part (one-piece portion) or several parts assembled to one another (e.g. at least two radially inner and outer parts which are each, independently of one another, based on one or more material which are secured to one another by mechanical or chemical means; advantageously, a first flexible material above the support and a second material termed rigid, and in any case more rigid than the first material, below the support); and/or

these portions can have thicknesses which are identical or not, measured in the mounting faces thereof and/or profiles which are identical or not, with flat surfaces (or not) in the front and/or side faces thereof.

It will furthermore be noted, that these axial, juxtaposed portions of reduced thickness(es) have the following advantages compared with existing support rings of split or sector type:
An easy mounting/unmounting, with a lesser risk of damaging the tyre, because the lip of a portion leaves a sufficient space at the tyre bead;

A possible movement of the tyre bead on either side of the ring during the mounting;
An increased reliability in mounting in case of dimensional variation with respect to the profile of the rim;

An almost continuous contact with the rim using a large number of portions, which improves the flat-run performances;

An improved ventilation during the run-flat of the material(s) used for the portions, which makes it possible to reduce the heating risk and therefore the softening of the ring and thus contributes to also improving the run-flat performances of the device; and

A limited propagation of cracks in case of ballistic impacts or other impacts, because of the juxtaposition of independent portions.

According to another characteristic of the invention, said portions can furthermore be threaded over at least one annular circumferential support link of said portions, which can thus be passed through by said at least one link between two adjacent link ends positioned facing said belt ends, in at least one threading zone for each portion which is separate from said at least one support and which is localised radially outside and/or radially inside and/or axially on either side of said at least one support.

It will be noted, that this threading of the portions in the manner of a pearl necklace makes it possible to connect them to one another such that they remain axially aligned against one another by rolling.

In addition, the presence of at least one annular link facilitates the mounting of the run-flat device in the tyre.

Advantageously, said at least one annular link can be selected from among metal links, for example formed of stranded cables (or not), the textile links, for example formed of cables, the elastic links, for example formed of elastomer grommets and combinations of at least two of said links.

According to a first embodiment example of the invention, said at least one support of each of the portions is formed, over all or part of said circumference:

at the belt ends, by a radial reinforcement extending from said support face and constituted of an axial base of a U-shaped groove or an axial side shoulder of each portion, and

outside of the belt ends, by a radially inner edge of a slot or transverse slot which is provided radially removing from said support face and which leads (or not) to at least one side face of each portion.

According to a second embodiment example of the invention, over all or part of said circumference, at and outside of said belt ends, said at least one support of each of the portions is formed on radially deformable elastic means which connect to one another, two portion parts, respectively radially inner and outer.

According to another characteristic of the invention, common to these first and second examples, the portions can be connected two-by-two to one another, over all or part of said circumference, by at least one shim which is radially ended by removing said at least one support and against which are mounted as a circumferential stop of the radially inner zones of two consecutive portions. In this case, said at least one shim can advantageously receive an end from said at least one link and/or comprise a multitude of shims which are inserted between the portions, adjacent two-by-two, and which are passed through by said at least one link outside of the link ends.

It must be noted, that in the case where no shim is provided with the ring, the or each annular link can be removed, once the support belt is implemented, advantageously locked, in the tyre. This makes it possible to reduce the weight of the mounted assembly.

Advantageously, over all or part of said circumference, the portions can each have a circumferential thickness which varies in an axial direction of the ring, for example with a staggered arrangement of side faces of the portions according to minimum and maximum alternating thicknesses. This staggered arrangement gives a better stability to the ring by blocking a possible rotation of the axial portions.

Also advantageously, over all or part of said circumference, the portions can each have a circumferential thickness which varies in a radial direction of the ring, for example which expands said mounting face to said support face. This variation in circumferential thickness which varies in a radial direction of the ring makes it possible to increase the surface of the support face.

In a variant, over all or part of said circumference, said portions are tilted obliquely from a radially inner zone of each portion, with respect to the substantially radial plane of this radially inner zone.

According to a first embodiment of the invention, said mounting face of all or part of said portions is suitable to fit an axial profile of said rim base, the rim being one-piece with a circumferential rim nave, all or part of said portions comprising shim means, such as a lip or tab, axially protruding over a side edge of each portion, which are suitable for wedging each portion in said nave.

As indicated above, these shim means at the mounting face of the ring can only be present in a limited number of portions, which means that the remaining portions can be exempt of any lip or shim tab in the rim nave.

According to a second embodiment of the invention, said mounting face of all or part of said portions is suitable for fitting a substantially flat axial profile of the base of the rim which has several blocks and is ended by two axially inner and outer rim edges, and all or part of the portions having an axial width, for example suitable for axially blocking by compression of the tyre beads against these edges.

A mounted assembly according to the invention for a motor vehicle comprises a wheel rim, a tyre mounted against two axially inner and outer rim edges and a run-flat device mounted on the rim and intended to support the tyre in a run-flat situation, which is such as defined above. This mounted assembly can be such that:

the rim is one-piece with a circumferential rim nave, said mounting faces of all or part of the portions being mounted in this nave over the whole axial width of the latter, or that

the rim comprises several blocks, and with a substantially flat base, the portions could axially block the tyre beads against these rim edges.

Generally, in reference to all the above-mentioned characteristics of the invention, it will be noted that said at least one support belt applied set back from the support face of the ring, does not interfere with the tyre in a run-flat situation and makes it possible to support the ring on the rim. The or each belt can be advantageously of metal collar type, in particular with respect to a one-piece rim with a rim nave, and be thicker or thinner in the radial direction, while being sufficiently flexible to be easily insertable inside the tyre and substantially cannot be deformed once locked opposite the forces transmitted when rolling, to effectively oppose the “centrifugation” of the ring rolling in the inflated state.

With respect to a multi-block rim, the or each belt can be of locking type (or not), being advantageously formed of a strap enclosed in material, secured to said at least one support of each portion (e.g. by adhering or mechanical fastening), or a metal rail with a fixed diameter, or also a reinforced rubber belt. Such a belt makes it possible to easily insert the ring inside the tyre, and is also designed to almost not be able to be deformed, opposite forces transmitted by rolling in the inflated state.

Regarding said connecting and locking means equipping said at least one belt according to the invention for the adjustable clamping thereof, they can be advantageously such as described in the abovementioned document EP-A1-2 233 752, although other lockable (or not) connectors can be used.

According to EP-A1-2 233 752, these means can be provided with a locking member, mounted secured to one of the ends of the belt, so as to occupy an unlocking position where the member is clear of these means for the clamping and unclamping of the belt, and a locking position where the member locks with them to as to oppose the unclamping. These means are capable of moving closer or farther away from these ends, by a rotation applied to said means respectively in the direction of a clamping or an unclamping of the belt, and this member is thus suitable for opposing to rotation of these means in the locking position. These means can comprise a cylindrical rod having, in the end portions thereof, two threads in opposite directions, guided in rotation in two transverse pins fixed to the ends to be connected, under the control of a member for moving the rod secured in rotation to a central portion of it.

Other characteristics, advantages and details of the present invention will emerge upon reading the following description of several embodiment examples of the invention given as an illustrative and non-limiting manner, the description being made in reference to the appended drawings, among which:

In the present description, the expressions, “axially inner” and “axially outer”, refer respectively to the sides of the rim intended to be rotated towards the inside and the outside of the vehicle, and “radially inner” and “radially outer” respectively to radial directions with respect to the rim becoming closer to it or farther away from it.

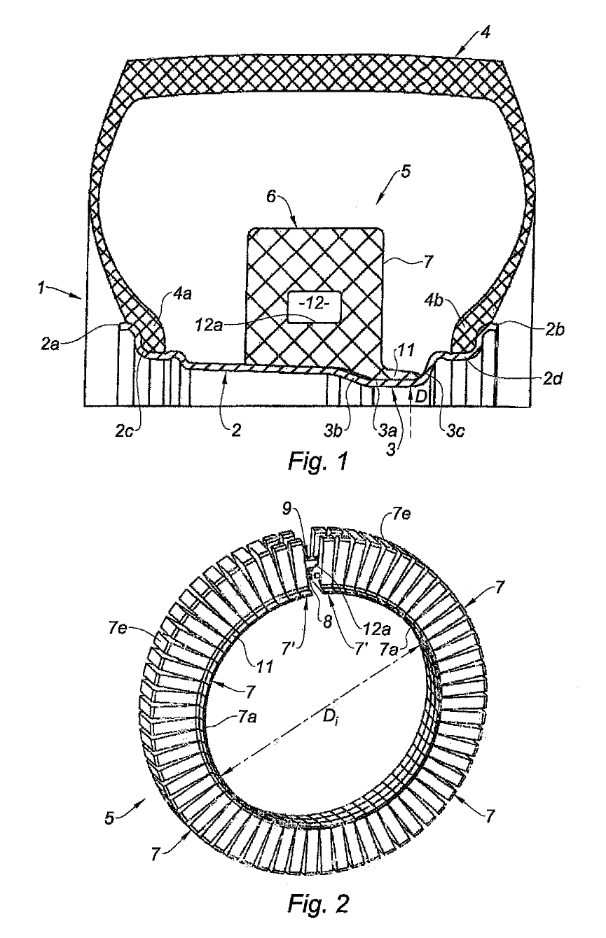

FIG. 1 is an axial, cross-sectional view of a mounted assembly according to the first embodiment of the invention incorporating a support ring with portions according to the first example of the invention (the visible portion being situated outside of the connected ends of the belt, not illustrated),

FIG. 2 is a side and perspective view of the device of FIG. 1 showing the portions of the ring passed through by a belt closed by connecting means, locked from the ends thereof,

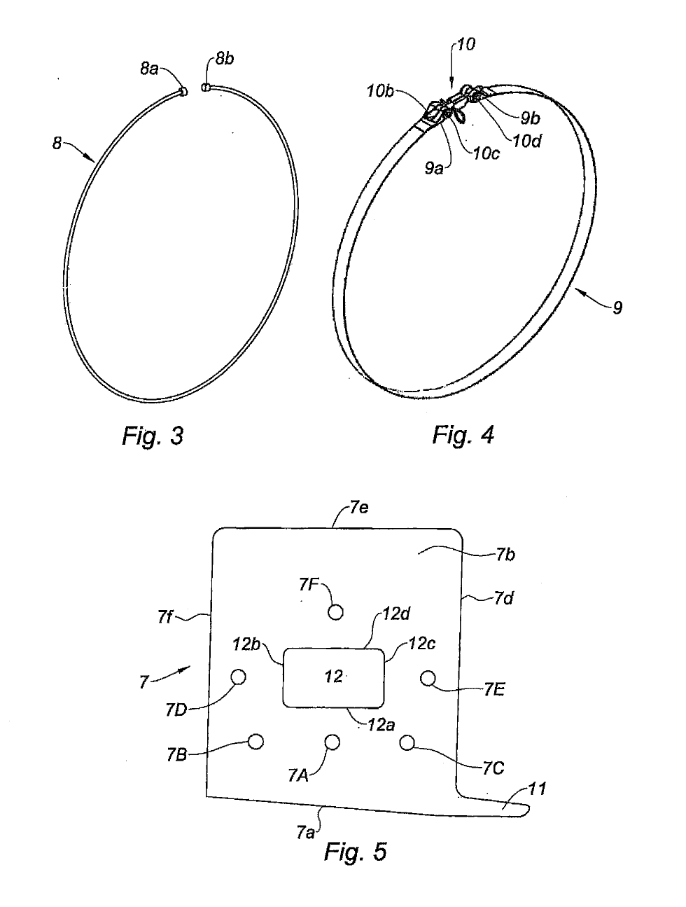

FIG. 3 is a side and perspective view of an annular link for circumferentially supporting the portions of the device of FIG. 3,

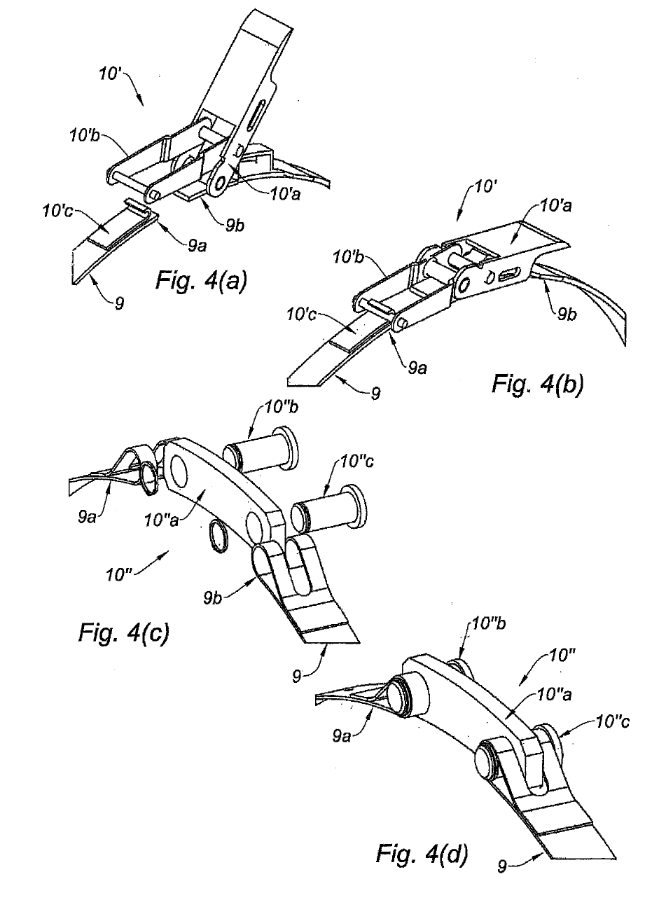

FIG. 4 is a side and perspective view of an example of a clamping belt provided with connecting means with adjustable and lockable clamping which can be used in FIG. 3,

FIGS. 4(a) and 4(b) are side and perspective views of an example of a clamping belt provided with connecting means with non-adjustable and lockable clamping which can be used in FIG. 3, in an unlocked position in FIG. 4(a) and in a locked position in FIG. 4(b),

FIGS. 4(c) and 4(d) are side and perspective views of an example of a support belt provided with lockable connecting means which can be used in FIG. 3, the connecting means ensuring no clamping, the unlocked position being represented in FIG. 4(c) and the locked position in FIG. 4(d);

FIG. 5 is a front view of a portion of a ring which can be used in a device according to the invention, under the variants in FIG. 1,

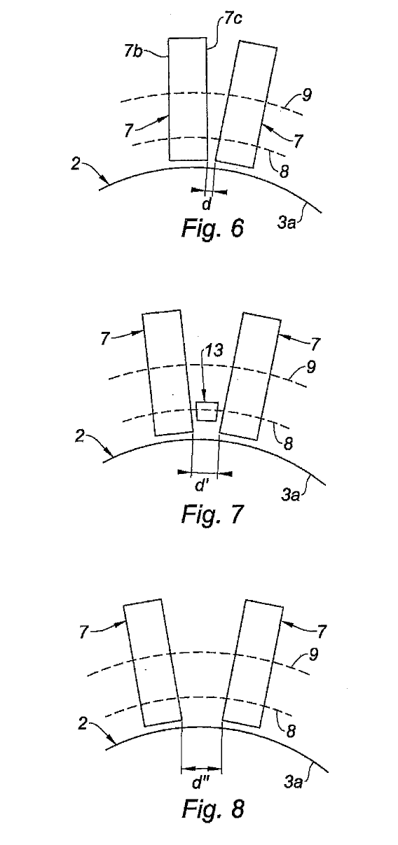

FIG. 6 is a side, partial, schematic view illustrating a tight mounting example, on a one-piece rim or multi-block rim, of two consecutive portions of a device according to the invention,

FIG. 7 is a side, partial, schematic view showing another tight mounting example, on a one-piece rim or multi-block rim, of two consecutive portions of a device according to the invention,

FIG. 8 is a side, partial, schematic view illustrating a spaced apart mounting example, on a one-piece rim or multi-block rim, of two consecutive portions of a device according to the invention,

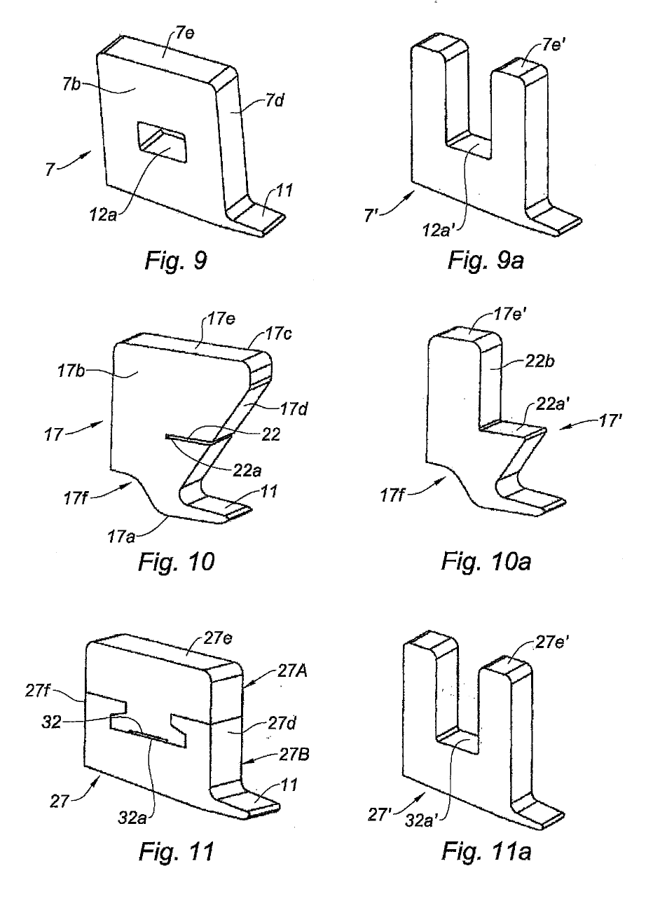

FIG. 9 is a top and perspective view of a portion according to said first example of the invention being situated outside of the ends to be connected to the belt, similar to that which can be seen in FIG. 1,

FIG. 9a is a top and perspective view of an end portion according to said first example of the invention, provided in an end to be connected to the belt and which could be combined with the portions according to FIG. 9,

FIG. 10 is a top and perspective view of a portion according to a variant of said first example of the invention being situated outside of the ends to be connected to the belt,

FIG. 10a is a top and perspective view of an end portion according to a variant of said first example of the invention, provided in an end to be connected to the belt and which could be combined with the portions according to FIG. 10,

FIG. 11 is a top and perspective view of a portion according to another variant of said first example of the invention being situated outside of the ends to be connected to the belt,

FIG. 11a is a top and perspective view of another end portion according to another variant of said first example of the invention, provided in an end to be connected to the belt and which could be combined with the portions according to FIG. 11,

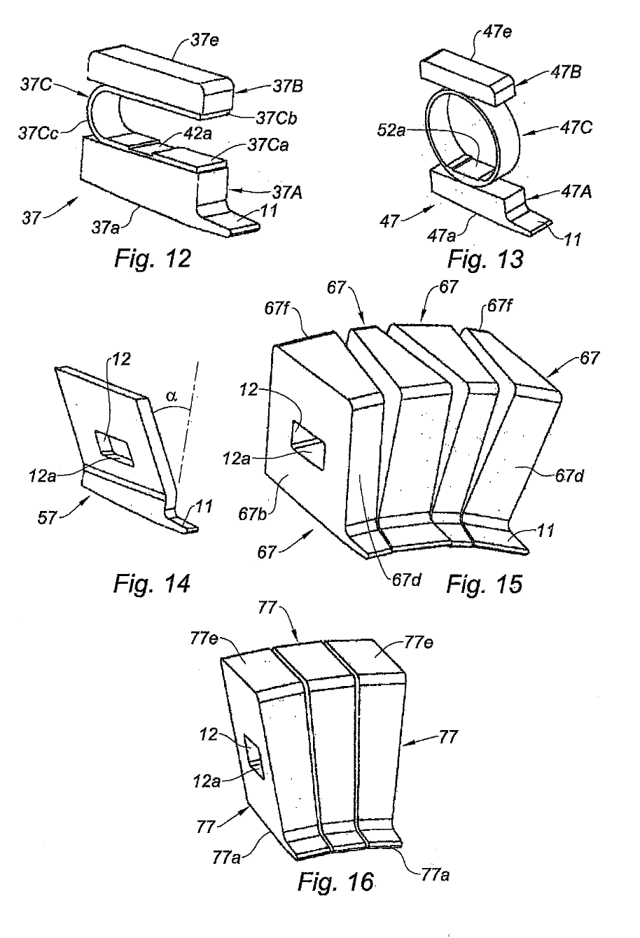

FIG. 12 is a top and perspective view of a portion according to said second example of the invention being situated outside of the ends to be connected to the belt,

FIG. 13 is a top and perspective view according to a variant of said second example of the invention being situated outside of the ends to be connected to the belt,

FIG. 14 is a top and perspective view of another portion according to said first example of the invention being situated outside of the ends to be connected to the belt and according to a variant of FIG. 9,

FIG. 15 is a partial top and perspective view of an arrangement according to the invention of tight portions alternately having an increasing and decreasing thickness from one side edge to the other,

FIG. 16 is a partial top and perspective view of an arrangement according to the invention of tight portions having an increasing thickness from the mounting face thereof to the support face thereof,

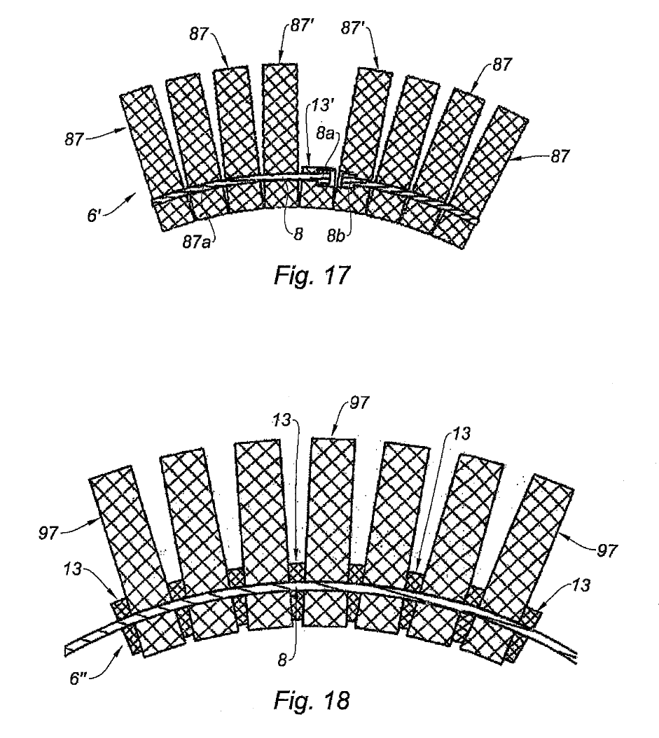

FIG. 17 is a partial, cross-sectional view in a median circumferential plane of a ring according to the invention, showing the use of one single shim between the two end portions of the ring at an opening of an annular support link such as that of FIG. 3, and

FIG. 18 is a partial, cross-sectional view in a median circumferential plane of a ring according to the invention, showing the use according to FIG. 7 of a multitude of shims between consecutive portions of the ring supported by such an annular link, outside of end portions;

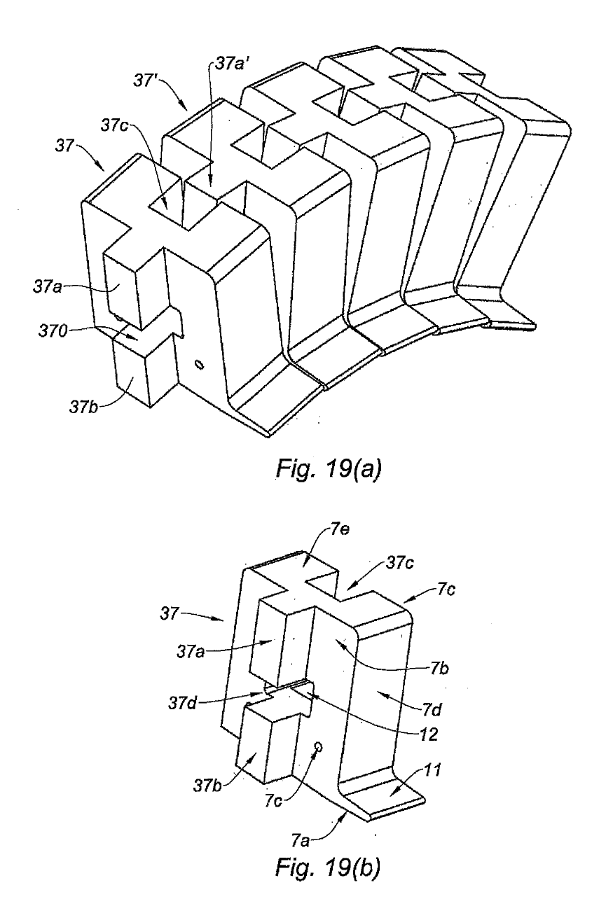

FIG. 19 comprises FIG. 19(a) which is a side and perspective view of a device which conforms with the invention showing other forms of portions which can be considered, making it possible to obtain tight and interlinked portions and FIG. 19(b) shows one of these portions, in an isolated manner, according to the same view;

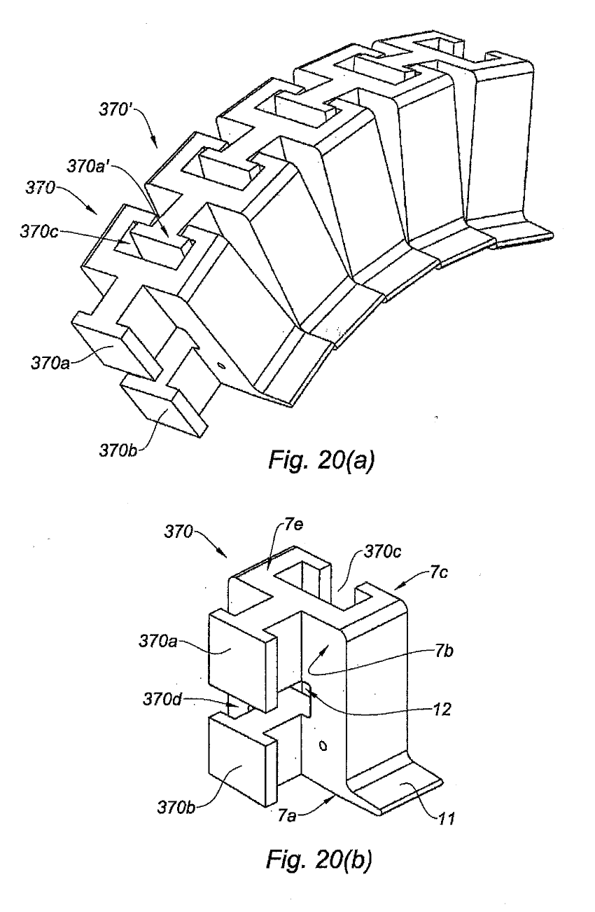

FIG. 20, which comprises FIGS. 20(a) and 20(b), represents another possible design for tight and interlinked portions, respectively according to a side and perspective view and according to the same view, for an isolated portion;

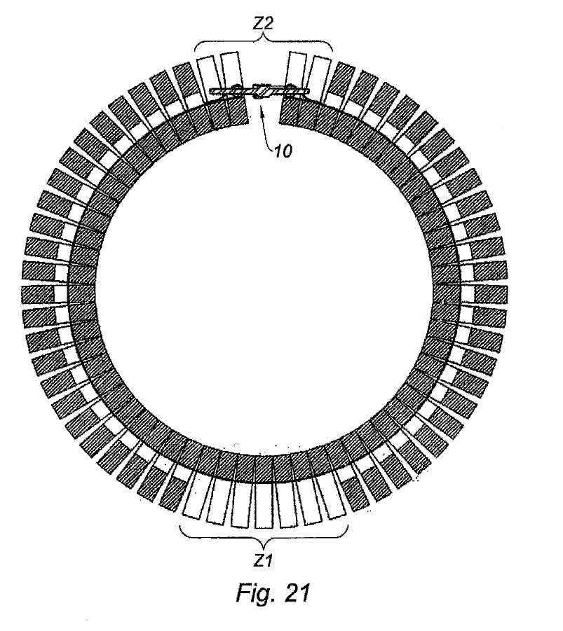

FIG. 21 is a cross-sectional view showing a device which conforms with the invention, wherein the distribution of the mass is balanced, by a removal of material over certain sectors;

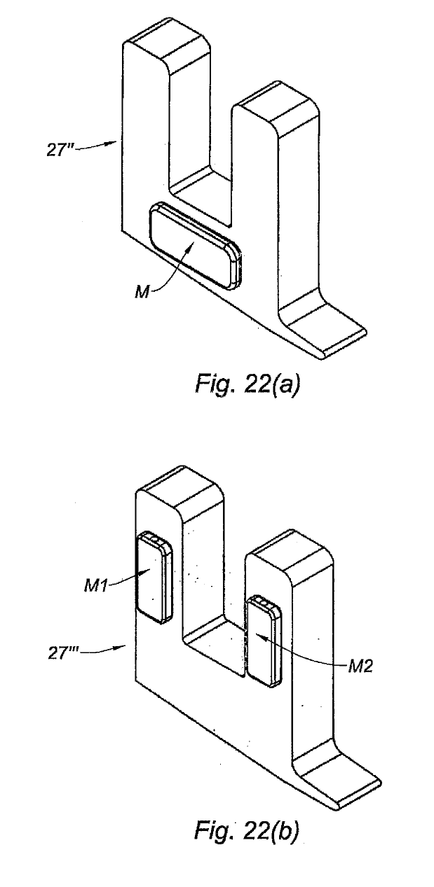

FIG. 22, which comprises FIGS. 22(a) and 22(b), is a perspective view of an isolated sector on which is provided one or more balancing masses.

The mounted assembly 1 illustrated in FIG. 1 according to the first embodiment of the invention comprises an asymmetric wheel rim 2 of one-piece type, comprising a circumferential rim nave 3, a tyre 4 mounted against the axially inner and outer edges 2a, 2b of the rim 2, and a run-flat device 5 mounted in the nave 3 and intended to support the tyre 4 following a fall in inflation pressure inside the mounted assembly 1.

The rim 2 comprises axially inner and outer rim seats 2c, 2d respectively intended to receive beads 4a, 4b of the tyre 4, each rim seat 2c, 2d being axially delimited by one of the edges 2a, 2b. In the example of FIG. 1, the nave 3 is with a base 3a (of diameter D) axially delimited by two oblique walls 3b, 3c, and the axially outer wall 3c of the base 3a results in the outer seat 2d.

The device 5 of FIGS. 1-2 is suitable for being positioned on the base 3a of the nave 3, and it comprises:

a support ring 6 comprising a multitude of n axial portions 7 (n=63 in the example of FIG. 2) juxtaposed in the circumferential direction in a tight manner at the edges facing the respective radially inner mounting faces 7a (of diameter Di) of the portions 7, which are supported between them by an circumferentially annular support links 8 passing through them such as that of FIG. 3, and

an annular support belt 9, for example metal with adjustable clamping, such as that of FIG. 4 and lockable, preferably via the connecting means 10 illustrated in FIG. 4 and described in document EP-A1-2 233 752.

The portions 7 which can be seen in FIG. 2, each have the same one-piece structure, the same production material, the same geometry and the same thickness, being specified that the structure (one-piece or with several parts), the material(s), the geometry (in particular, the profile of the front faces 7b, 7c) and/or the thickness of the portions 7 could vary in the radial and/or axial and/or circumferential direction of the ring 6, as explained above.

All or some of the portions 7 of the ring 6 each has/have, in the mounting face 7a thereof, means 11 to wedge the portion 7 in the rim nave 3, constituted in this example, of a circumferential lip 11 which is axially formed protruding over the axially outer side face 7d of each portion 7 and which forms an integral part of it. This shim lip 11 has an axial width of around that of the base 3a of the nave 3, because it is designed to be applied on this base 3a and in contact with the outer side wall 3c of the nave 3.

Each portion 7, outside of the end portions 7′ of the ring 6 to be connected to one another, has, in the example of FIGS. 1 and 2, a transverse, cross-sectional slot 12, for example rectangular, which leads to the front 7b and rear 7c front faces of the portion 7 and which is radially formed between the mounting face 7a and the radially outer support face 7e of the portion 7 (substantially radially halfway up the portion 7 in this example) and axially centred between the two side faces 7d and 7f of the portion 7. A radially inner edge 12a of the slot 12 defines, for each portion 7, a support receiving the belt 9.

Also, with respect to FIGS. 2, 3 and 5, each portion 7 can optionally have radially between the mounting face 7a and the inner edge 12a of the slot 12, an axially central orifice 7A passed through by the annular link 8 for supporting the portions 7 which, in the example of FIG. 3, is formed of a split ring (i.e. with two ends 8a, 8b situated facing one another and defining an opening of the link 8 situated radially at the same level on the circumference of the ring 6 as the connecting means 10 of the ends 9a, 9b of the belt 9), in this case, similar to the form of a round, cross-sectional grommet. It could otherwise be like this, since this annular link 8 could be presented in the form of a square or rectangular, cross-sectional grommet, or of a strap or also a flat blade.

As can be seen in FIG. 2, the tight portions 7 are almost not spaced apart from one another over the circumference of the ring 6 at the mounting face 7a thereof (except for the interval between the two end portions 7′ connected by the means 10, an interval which can be of 50 mm, for example to make it possible to access, under good conditions, these means 10), such that the total sum of consecutive spaces measured between the portions 7, 7′ at this face 7a is clearly less than π·D/16, even being less than π·D/32. In addition, the portions 7 each have a circumferential thickness measured in the mounting face 7a, which in this example, is less than or equal to π·D/60.

As illustrated in FIG. 4, the belt 9 according to the invention is formed by an annular strip of which the pair of ends 9a, 9b are connected to one another by the connecting means 10 with adjustable and lockable clamping, by a locking member 10a mounted pivoting in an end 9b. These means 10 are constituted by a cylindrical rod 10b of stud type being ended by two threads in opposite directions, guided in rotation in two transverse pins 10c, 10d fixed to the ends 9a, 9b to be connected, under the control of a nut for moving the rod 10b secured in rotation to a central portion of the rod 10b.

Using connecting means 10 with adjustable and lockable clamping for the belt 9 is not compulsory.

Indeed, connecting means 10′ with non-adjustable and lockable clamping can be used, as is illustrated in FIGS. 4(a) and 4(b), respectively in an unlocked position and in a locked position. In these figures, the non-adjustable and the locking clamping is done by a fitting type system 10′. It comprises a locking member 10′a, 10′b comprising a first part 10′a mounted pivoting on one 9b of the ends 9a, 9b of the belt 9 and a second part 10′b, mounted pivoting on the first part 10′a. The other end 9a of the belt is equipped with a hook 10′c mounted fixed on the belt, with which the second part 10′b of the member 10′ can lock to ensure the locking.

In a variant, connecting means 10″ can also be used, which ensure locking, without clamping. A suitable example, is a plate/pin type system, as is shown in FIGS. 4(c) and 4(d), respectively in an unlocked position and in a locked position. More specifically, a plate 10″a equipped, at the ends thereof, with orifices can thus be provided, making it possible to make the pins 10″b, 10″c pass through. The ends 9a, 9b of the belt 9 are arranged in loop forms to receive, on the one hand, the plate 10″a, and on the other hand, the pins 10″b, 10″c.

In FIG. 5, various locations 7A, 7B, 7C, 7D, 7E, 7F which can be used in a non-limiting manner to make the link 8 pass through each portion 7 have been represented, including:

axially on either side of the axially central place 7A of FIG. 2, two radially inner side places 7B, 7C localised radially between the mounting face 7a and the inner edge 12a of the slot 12,

axially on either side of the side edges 12b, 12c of the slot 12, two radially intermediate side places 7D, 7E localised radially at the same median height as the light 12, and

axially centred on the slot 12, a radially outer central place 7F localised radially between the outer edge 12d of the slot 12 and the support face 7e.

In a variant of the tight juxtaposition of FIG. 2 with there being no axial clearance in the circumferential direction between consecutive portions 7, the following has been illustrated:

in FIG. 6, a juxtaposition also termed tight, in the sense that the circumferential axial clearance d between consecutive portions 7 (outside of end portions 7′) to be connected together by the means 10 is very low, here being typically around 1 mm;

in FIG. 7, a juxtaposition could also be qualified tight, in the sense that at least one shim 13 of reduced radial height between radially inner zones of consecutive portions 7, two-by-two in inserted (the or each shim 13 not impeding the passing of the portions 7 through the or each belt 9 and which could optionally be passed through the or each annular support link 8), such that the circumferential axial clearance d′ between the or each shim 13 and the two portions 7 that it separates if also very low (typically of around 1 mm, outside of end portions 7′ to be connected together by the means 10); and

in FIG. 8, a juxtaposition, not tight but spaced apart with a space d″ between consecutive portions 7 in the circumferential direction which could be of around 10 mm or more.

It will be noted, that these FIGS. 6-8 schematically identify, by dashed lines, the passing of the consecutive portions 7, tight (FIGS. 6 and 7) or not (FIG. 8) by at least one radially inner annular support link 8 by through at least one radially outer belt 9 with respect to this link 8.

FIGS. 9-9a, 10-10a, 11-11a illustrates three geometries which can be used, among others, for the portions 7 outside of those situated at the belt ends 9a, 9b to be connected together (current portions 7 of FIGS. 9, 10, 11), and only for the end portions 7′ to be connected (FIGS. 9a, 10a, 11a).

The current portion 7 of FIG. 9 is similar to that of FIG. 1, while the end portions 7′ of FIG. 9a each being distinguished by a radial clearing outside of the support 12a to make it possible for the mounting of the means 10, so as to form from the support face 7e′, a U-shaped groove of which the base 12a′ defines a reinforcement (at the same radial height as the inner edge 12a of the light 12) on which are applied the two belt ends 9a, 9b to be connected.

The current portion 17 of FIG. 10 has, unlike FIG. 9, a slot 22, laterally leading to the axially outer side face 17d of the portion 17, the slot 22 being formed substantially radially halfway up the portion 17 in this example, and being suitable for receiving, through the radially inner edge thereof forming a support 22a, the belt 9 which is threaded through the side face 17d. In addition, the portion 17 has an axial width, mainly decreasing from the support face 17e thereof to the mounting face 17a thereof (i.e. a mainly trapezoidal profile for the front faces 17b, 17c thereof), which is not substantially flat, contrary to that of FIG. 9, but of rounded shape up to the chock lip 11 thereof, which only defines the most radially inner portion of the portion 17. Regarding the end portions 17′ of FIG. 10a, they are distinguished from the portion 17 in that the supports thereof 22a′ are constituted by an axial shoulder which is formed at the same radial height as the support 22a of the slot 22 and which is extended at a right angle by a radial portion 22b, perpendicular to the support face 17e′ of the portion 17′ (which is thus extended radially towards the inside by a tread of a stair leading to the shoulder 22a′). In FIGS. 10 and 10a, also the presence of a bevel 17f, 17′f is noted. This facilitates, even makes it possible, for the mounting of the ring on a rim of narrow width, without impeding the movement of the tyre beads and by keeping a support face sufficiently wide.

The current portion 27 of FIG. 11, has as that from FIG. 9, an axially central slot 32 situated radially between the mounting face 27a and the support face 27e and axially between the side faces 27d and 27f, but unlike FIG. 9:

the slot 32 has a very reduced radial height forming a slot forming a support 32a, capable of being passed through by the belt 9 by closely enclosing it, and

the current portion 27 is constituted of a mechanical assembly (for example, by bead/mortise type interlocking) of an adhering or overmoulding of a radially outer part 27A on a radially inner part 27B, these parts 27A, 27B could be constituted (or not) of the same material or mixture of materials.

It will be noted, that the belt 9 must be applied beforehand on the support 32a of the inner part 27B (which defines a radially inner edge 32a of the light 32), before assembling the outer part 27A on the inner part 27B equipped with the belt 9.

Regarding the end portions 27′ of FIG. 11a, they can be, for example, similar to that of FIG. 9a with, at the same radial height as the light 32, a U-shaped groove base support 32a′ arranged from the support face 27e′ and receiving the belt ends 9a, 9b, cleared in the radial direction to make it possible to access the means 10.

The current portions 37, 47 of FIGS. 12-13 illustrate the second example of the invention, with, in the two cases, three parts 37A, 37B and 37C, 47C which are radially superposed and assembled on one another (by mechanical assembly, for example, by riveting, or chemical assembly, for example, by adhering or overmoulding), and which comprise two radially inner 37A, 47A and outer 37B, 47B rigid parts, respectively defining the mounting face 37a, 47a and the support face 37e, 47e and an intermediate elastic part 37C, 47C connecting them to one another in the manner of a deformable spring blade in the radial direction. The parts 37A, 37B and 37C, 47C are in these examples constituted of mainly rectangular front face blocks, and the intermediate part 370, 47C (preferably metal) bears against the parts 37A and 37B, 47A and 47B (the thicknesses of the parts 37A, 37B, 37C and 47A, 47B, 47C in the circumferential direction being identical or similar) by forming at least one circular arc between the parts 37A and 37B, 47A and 47B. In addition, the intermediate part 37C, 47C forms a receiving support 42a, 52a suitable for axially wedging the belt 9 in the most radially inner zone that it has. More specifically:

the intermediate part 37C of FIG. 12 is substantially c-shaped, of which the two axial parallel branches 37Ca, 37Cb which are fixed to the parts 37A, 37B are connected to one another by a connecting portion 37Cc in a circular arc, with the inner branch which is provided with the axial shim support 42a of the belt 9, and

the intermediate part 470 of FIG. 13 is ring-shaped of which the axis of symmetry is perpendicular to the front faces of the parts 47A and 47B and which is secured to the latter tangentially by the radially inner and outer zones of the ring, with the outer face of the inner zone which is provided with the axial shim support 52a of the belt 9.

It must be noted, that for the embodiments of FIGS. 12 and 13, the flexibility of the portions in the radial direction can be obtained by varying the geometry of the portions. This can make it possible, incidentally, to reduce the weight of the mounted assembly.

The portion 57 illustrated in FIG. 14 illustrates a variant of FIG. 9 which can be used for the current portions 57 outside of those situated at the belt ends 9a, 9b to be connected together. This portion 57 which is also equipped with a slot 12 is distinguished mainly from that of FIG. 9, in that it is tilted obliquely (by an acute angle a, for example, of between 5° and 30°) from a radially inner zone of the portion 57 comprising the shim lip 11, with respect to the substantially radial plane of this inner zone. This tilting makes it possible for a side contact between two neighbouring portions.

The current tight portions 67 illustrated in FIG. 15 illustrate an staggered arrangement of the successive side portion faces 67d, 67f of which the front faces 67b, 67c are similar to those of portion 7 of FIG. 9, because two consecutive portions 67 according to FIG. 15 are of different geometries since they have, in the circumferential direction, respectively a thickness which axially increases towards the inside and which axially increases towards the outside. It is understood that this alternate arrangement makes it possible to juxtapose the portions 67 in axial alignment around the rim 2.

The current tight portions 77 illustrated in FIG. 16 illustrate a possible arrangement for identical current portions 77 between one another, similar to that of FIG. 9, but which have, in the circumferential direction, a thickness which radially increases towards the outside, in this example, continuously from the mounting face 77a to the support face 77e of each portion 77. It can be seen that the portions 77 are thus tight over all the respective radial heights thereof.

FIG. 17 shows current tight portions 87 and the two end portions 87′ of a ring 6′ according to a variant of the invention, characterised by the insertion of a shim 13′ between the end portions 87′, with the shim 13′ which is passed through by one of the two ends 8a of an annular support link 8 such as that of FIG. 3. It can be seen that the shim 13′ has the radially inner face thereof aligned with the mounting faces 87a respective of the portions 87, 87′, and has the radially outer face thereof situated radially removed from the place halfway up the portions 87, 87′ which is suitable for being passed through by the or each clamping belt 9 locked between the end portions 87′.

It will be noted, that the shim 13′ makes it possible to be opposite the run-flat sliding of the end portions 87′, and to thus avoid a “domino” type propagation effect on the other portions 87.

FIG. 18 shows, in a variant of FIG. 17, current portions 97 (i.e. outside of end portions) also tight by way of a multitude of shims 13 in a ring 6″, conforming with the diagram of FIG. 7. Each shim 13 has a reduced radial height between the radial inner zones of consecutive portions 97, and is only passed through by the or each annular support link 8 so as to not impede the passing of the portions 97 through the or each clamping belt 9, radially external to the link 8.

It will be noted, that the shims 13 make it possible to optimise the common contact between the portions 97.

In the description above, the wheel rim 2 is asymmetrical, with in particular a rim base of diameter D. It could however provide a flat rim. In this case also, a rim base can be defined for the flat rim.

Moreover, it must be noted, that with a flat rim, it can sometimes possible to not provide a clamping function for the belt 9. Indeed, the belt 9 can be avoided from the clamping components, fixed or adjustable, to only conserve the general support function thereof, with a locking.

Generally, and in reference to all of the examples having just been described (the references of FIG. 9 being revisited below, only for simplification purposes), the mounting of a device 5 according to the invention inside a mounted assembly 1 comprises, for example, the following steps (before inflation and balancing of the tyre 4):

assembly of a linear strip (i.e. flat, not ring-shaped 6) comprising all of the current portions 7 and juxtaposed ends 7′, tight or spaced apart, which are passed through by said at least one support belt 9 and possibly by said at least one annular support link 8 with optional intercalation of one or more shims 13 or 13′,

shaping of this ring-shaped strip 6 equipped with the belt 9 in a non-clamped position inside the tyre 4,

passage over the rim 2 of a bead 4a of the tyre 4 containing the ring 6,

passage over the rim 2 of the ring 6 equipped with the belt 9,

passage of the second bead 4b of the tyre 4 over the rim 2 to end the mounting.

When the support belt provided clamping, the passage over the rim 2 of the ring 6 equipped with the belt, is achieved with an unclamped belt. Then, clamping of the ring 6 against the rim by the belt is achieved, via the lockable connecting means.

A specific case of tight sectors is represented in FIGS. 19(a) and 19(b) and, according to a design variant, in FIGS. 20(a) and 20(b).

In all of these figures, the sectors 37, 37′; 370, 370′ are proposed, of which the form makes it possible for an interlocking between two consecutive sectors. Thus, said tight portions 37, 37′; 370, 370′ are connected to one another, two-by-two, by interlocking.

To understand the specific form of a sector 37 (FIG. 19(b)), it can be described by comparison with the sector 7 of FIG. 5. Between these FIGS. 19(b) and FIG. 5, the same references mean identical elements and are therefore not described in a detailed manner. On a front face 7b (front), the sector 37 comprises an upper protusion 37a and a lower protusion 37b, each formed in an protuberance from the front face 7b. In this case, each protusion is presented in the form of a parallelepiped. Also, on this front face 7b, the two protrusions 37a, 37b are separated by an opening 37d facing the opening 12. These openings 37d, 12 make it possible to make the support belt pass, of which the design can be selected according to the different variants described above. Moreover, on the other front face 7c (rear), opposite the first front face 7b, an opening 37c is provided, extending between the radially inner mounting face 7a, suitable for being mounted on said rim base and the radially outer support face 7e, suitable for supporting the tyre in a run-flat situation.

As can be seen in FIG. 19(a), the opening 37c has suitable dimensions for receiving the protusions 37′a of an adjoining sector 37′. In this case, the opening 37c therefore also has a parallelepipedal form.

Such a design (interlocking) facilitates the mounting of the sectors to one another by providing them with a guide. Moreover, although the support belt is sufficient to support the sectors in position, this interlocking contributes to limiting the movements from one sector to the other, in the axial direction (axis of the wheel) and therefore involves a greater stability with an axial force. This further provides a better distribution of the load over the portions in contact with the tyre. Finally, this makes it possible for a high decrease in vibration increases thanks to a continuity of the rolling strip.

In the FIGS. 20(a) and 20(b), a variant of the design proposed in FIGS. 19(a) and 19(b) is shown, a variant also making it possible for an interlocking between two consecutive sectors.

In comparison to FIGS. 19(a) and 19(b), it is noted, that the form of the protusions 370a, 370d of a sector 370 is different and, consequently that the opening 370c, suitable for receiving protusions 370a′ of another sector 370′, also has a different form. The opening 370d, provided between the two protusions 370a, 370b to let the support belt pass, can be identical to that of the opening 37d. The whole remainder is identical.

In this case, the protusions 370a, 370b have a form of which the section is T-shaped.

Finally, it must be noted, that advantageously, the sectors, and whether the design is considered for a sector, will be selected to ensure, over all of the run-flat device, a balanced mass distribution.

Indeed, and for example, if the assembly view of FIG. 2 is referred back to, the presence of connecting and locking means 10, 10′, 10″ involves a mass removal, at the sectors, to leave access to these locking means. On the contrary, the presence of the connecting and locking means 10, 10′, 10″ involves a local addition of mass, which does not necessarily compensate the mass removal made at the sectors.

In such a case, the mass of the run-flat device is not distributed in a balanced manner, which generates a slight out-of-balance effect likely to be damaging.

Even if this slight out-of-balance effect can be absolutely acceptable, it remains advantageous to eliminate it. Also, it is advantageous that the run-flat device has a balanced distribution of the masses.

To this end, several solutions can be considered.

A first solution is to achieve a mass removal, at a sector zone Z1 situated, on the run-flat device, diametrically opposite the zone Z2 comprising said connecting and locking means 10. In practice, for example, sectors 27′ such as represented in FIG. 11a can be provided on the zone Z2, and outside of the zones Z1 and Z2, of sectors 7 such as represented in FIG. 5 or 9.

It is the solution which is shown in FIG. 21. Indeed, at the zone Z2, the addition of mass of connecting and locking means 10 does not generally compensate the mass loss of sectors (for example, of the type of FIG. 11a) making it possible to leave access to these connecting and locking means 10.

A second solution is, for example, to add runners M on the sectors of the zone Z2 to precisely locally compensate the mass loss thereof with respect to the sectors which are outside of the zone Z2. In this case, it is not necessary to implement a zone Z1.

This is what is shown, according to two implementation examples, in FIGS. 22(a) and 22(b).

More specifically, in FIG. 22(a), a sector 27″ has been shown according to a perspective view, akin to the sector 27′ of FIG. 11a, but comprising a runner M. This runner M makes it possible to weigh down the sector 27″ such that the mass thereof is identical to that of a sector 7 such as shown in FIG. 5 or FIG. 11 and used outside of the zone Z2.

Similarly, in FIG. 22(b), a sector 27″′ has been shown according to a perspective view, akin to the sector 27′ of FIG. 11a, but comprising two runners M1, M2. These runners M1, M2 make it possible to weigh down the sector 27″′ such that the mass thereof is identical to that of a sector 7 such as shown in FIG. 5 or FIG. 11 and used outside of the zone Z2.

A third solution (not shown) is to provide this balancing mass within the support belt.

1-19. (canceled)

20. Run flat device for a mounted assembly of a motor vehicle comprising a wheel rim having a rim base of diameter D and a tire mounted on the rim, the device being suitable for supporting the tire and in a run-flat situation and comprising:
a support ring comprising a multitude of axial portions and which are juxtaposed over a circumference of the ring and which define a radially inner mounting face suitable for being mounted on said rim base and a radially outer support face suitable for supporting the tire in a run-flat situation, each of said portions having at least one support situated radially between said mounting face and said support face, and
at least one support belt which surrounds the ring over said circumference, so as to support it, substantially in contact with said rim base and which passes through said portions by being applied on at least one said support of each of them,
wherein said portions are not hinged to one another and are tight or spaced apart from one another over said circumference by a total sum of consecutive spaces, measured between said portions at said mounting face, which is less than π·D/2.

21. Device according to claim 20, wherein said portions each have, over all or part of said circumference, a circumferential portion thickness measured at said mounting face which is less than or equal to π·D/25.

22. Device according to claim 20, wherein said at least one support belt has two belt ends spaced apart and connected to one another by connecting and locking means capable of locking at least one said belt, this locking being able to ensure an advantageously adjustable clamping of said portions.

23. Device according to claim 22, wherein said portions are furthermore threaded on at least one annular circumferential support link of said portions, which are passed through by at least one said link between two adjacent link ends. positioned facing said belt ends, in at least one threading zone for each portion which is separate from at least one said support and which is localized radially outside and/or radially inside and/or axially on either side of at least one said support.

24. Device according to claim 23, wherein said at least one annular link is selected from metal links, for example formed of stranded cables or not, textile links, for example, formed of cables, elastic links, for example formed of elastomer grommets and combinations of at least two of said links.

25. Device according to claim 22, wherein over all or part of said circumference, at least one said support of each of said portions is formed:
at said belt ends, by an inner radial reinforcement extending from said support face and consisting of an axial base of a U-shaped grove or of a lateral axial shoulder of each portion, and
outside of said belt ends, by an inner radially edge of a light or through slot which is provided radially removed from said support face and which leads to (or not) on at least one side face of each portion.

26. Device according to claim 22, wherein over all or part of said circumference, at and outside of said belt ends, at least one said support of each of said portions is formed on radially deformable elastic means which connect, to one another, two respectively radially inner and outer portion parts.

27. Device according to claim 20, wherein over all or part of said circumference, said portions each have a circumferential thickness which varies in an axial direction of the ring, for example with a staggered arrangement of side faces and of said portions according to the alternating minimum and maximum thicknesses.

28. Device according to claim 20, wherein over all or part of said circumference, said portions each have a circumferential thickness which varies in a radial direction of the ring, for example which increases from said mounting face to said support face.

29. Device according to claim 20, wherein over all or part of said circumference, said portions are tilted obliquely from a radially inner zone of each portion, with respect to the substantially radial plane of this radially inner zone.

30. Device according to claim 20, wherein said mounting face of all or part of said portions is suitable for fitting an axial profile of said rim base, the rim being one-piece with a circumferential rim nave, all or some of said portions comprising shim means, such as a lip or tab axially protruding over a side edge of each portion, which are suitable for wedging each portion is said nave.

31. Device according to claim 20, wherein said mounting face of all or part of said portions and is suitable for fitting a substantially flat axial profile of said rim base, the rim being multi-block and ending by two axially inner and outer rim edges, and all or some of said portions having an axial width, for example suitable for axially blocking, by compression, the beads of the tire against which are said rim edges.

32. Device according to claim 20, wherein said tight portions are connected to one another, two-by-two, by interlocking.

33. Device according to claim 20, wherein it has a balanced mass distribution.

34. Device according to claim 20, wherein said portions are connected two-by-two, to one another, over all or part of said circumference, by at least one shim which ends radially recessed from at least one support and against which the radially internal zones of two of said consecutive portions are circumferentially abutted.

35. Device according to claim 34, wherein at least one shim receives one end of at least one link and/or comprises a multitude of shims inserted between said portions, two-by-two, adjacent and passed through by at least one link outside of said link ends.

36. Mounted assembly for a motor vehicles, comprising a wheel rim, a tire mounted against two axially inner and outer rim edges, and a run-flat device mounted on the rim and intended to support the tire in a run-flat situation, wherein the device is such as defined in claim 20.

37. Mounted assembly according to claim 36 wherein the rim is one-piece with a circumferential rim nave, wherein said mounting faces of all or part of said portions and are mounted in said rim nave over the whole axial width of the latter.

38. Mounted assembly according to claim 36 wherein the rim is multi-block and with a substantially flat base, wherein said portions axially block the beads of the tire against said rim edges.
